(19) United States
(12) Patent Application Publication
(10) Pub. No.: US 2010/0045765 A1
(43) Pub. Date: Feb. 25, 2010

(54) PRINTER AND PRINTING PAPER

(75) Inventors: Akira Miyakawa, Tokyo (JP); Shoji Kikuchi, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/540,786

(22) Filed: Aug. 13, 2009

(30) Foreign Application Priority Data
Aug. 19, 2008 (JP) 2008-210763

(51) Int. Cl. B41J 2/47; B42D 15/00

(52) U.S. Cl. 347/225; 283/74

(57) ABSTRACT

A printer includes a printing unit configured to print on a sheet medium, a reading unit configured to read an identification mark when a sheet medium on which the identification mark is formed is used, and a control unit configured to specify a print setting for the sheet medium based on a read result of the reading unit, wherein the identification mark is a coded pattern drawn using a material containing a substance that scatters or absorbs ultraviolet light and containing no fluorescent substance, and wherein the reading unit includes an emitter configured to mainly emit ultraviolet light and a detector configured to detect fluorescence generated by excitation from a fluorescent whitening agent contained in the sheet medium and modulated by the coded pattern.

### BACKGROUND OF THE INVENTION

1. Field of the Invention

The present invention relates to a printer which records an image on a sheet medium, a setting method of the printer, and printing paper.

2. Description of the Related Art

Types of sheet medium that can be used as printing paper in a printer, for example, in an inkjet printer, have been diversified. Examples of such various types of sheet medium include printing paper that has an ink receiving layer on a printing surface thereof to improve photo image quality, thick paper such as postcards, and cloth that is printable by a printer.

An amount of ink bleeding and a condition of color development depend on the type of sheet medium. Therefore, an ink discharge amount and a number of ink discharge ports are set according to the type of sheet medium to acquire optimum image quality. In general, a user designates the type of sheet medium in a printer driver.

However, a number of options for such designation has increased along with an increase in the types of sheet medium, so that user operation has become complex. On the other hand, the printer cannot determine whether a setting is appropriate if the user has made an error in the designation due to such complexity. As a result, the printer may print in a low quality mode (i.e., a high speed mode) even if the user uses a high-grade paper that enables high quality printing. On the contrary, the ink may be excessively consumed if the printer prints on a low-grade paper in a high quality mode.

Further, when a network printer is shared by a plurality of users, there is a case where the user cannot determine which type of sheet medium is actually set in the printer. In such a case, it is necessary for the user to confirm the sheet medium that is actually set in the printer to designate the type thereof, which is an inefficient procedure.

To solve the above-described problems, U.S. Pat. No. 6,036,298 discusses a method in which the printer itself detects the type of sheet medium. More specifically, an identification mark is placed in a margin on a print side of the sheet medium, or an invisible identification mark is placed on the print side. The type of sheet medium is identified by a sensor which reads the identification mark.

In the method discussed in U.S. Pat. No. 6,036,298, the identification mark is placed on a back side of the sheet medium opposite to the print side. The sensor provided within the printer optically reads the identification mark from the print side and identifies the type of sheet medium. To realize such a method, the identification mark is required to be a clear mark which can be read from the opposite side. However, if the identification mark is too noticeable, visual quality of printing may be degraded, or the identification mark may be visible from the print side of the sheet medium after printing. On the other hand, in the conventional method, the identification mark is placed on the print side and read from the print side. The image is then printed over the identification mark, so that the image quality of the overprinted area may become degraded.

### SUMMARY OF THE INVENTION

The present invention is directed to a printer that is highly practicable and can reliably detect an identification mark which may not be visually noticeable and can identify a type of sheet medium based on the detection, and further directed to a setting method of the printer and printing paper for that purpose. The present invention is further directed to a printer that can separately dispose a printing unit and a reading unit configured to read an identification mark, and realize miniaturization and high practicability.

According to an aspect of the present invention, a printer includes a printing unit configured to print on a sheet medium, a reading unit configured to read an identification mark when a sheet medium on which the identification mark is formed is used, and a control unit configured to make a print setting for printing on the sheet medium based on a read result of the reading unit, wherein the identification mark is a coded pattern drawn using a material containing a substance that scatters or absorbs ultraviolet light and containing no fluorescent substance, and wherein the reading unit includes an emitter configured to mainly emit ultraviolet light and a detector configured to detect fluorescence generated by excitation from a fluorescent whitening agent contained in the sheet medium and modulated by the pattern.

According to another aspect of the present invention, a printing paper made of a substance containing fluorescent whitening agent includes an identification mark formed on a side opposite to a print side, which is a coded pattern of information for identifying a type or a size of a printing paper, and is drawn using a material containing a substance that scatters or absorbs ultraviolet light and containing no fluorescent substance.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a perspective view illustrating an external appearance of a printer according to an exemplary embodiment of the present invention.

FIG. 2 illustrates a cross-sectional view of an internal configuration of the printer illustrated in FIG. 1.

FIG. 3 illustrates a configuration of a reader according to the exemplary embodiment of the present invention.

FIG. 4 illustrates another example of a configuration of a reader according to the exemplary embodiment of the present invention.

FIGS. 5A and 5B illustrate a sheet medium and an identification mark formed on the sheet medium according to the exemplary embodiment of the present invention.

FIG. 6 illustrates an example of a waveform of an output signal from the reader according to the exemplary embodiment of the present invention.

FIG. 7 illustrates an example of an output signal processing method according to the exemplary embodiment of the present invention.

FIG. 8 illustrates an example of an output signal processing method according to the exemplary embodiment of the present invention.

FIG. 9 illustrates an example of a display on a user interface according to the exemplary embodiment of the present invention.

FIG. 10 illustrates a cross-sectional view of an internal configuration of a printer according to another exemplary embodiment of the present invention.

FIG. 11 is a perspective view illustrating an external appearance of the printer illustrated in FIG. 10.

### DETAILED DESCRIPTION OF THE EMBODIMENTS

Various exemplary embodiments, features, and aspects of the invention will be described in detail below with reference to the drawings.

An exemplary embodiment of the present invention applied to an inkjet printer will be described with reference to the drawings. The present invention is applicable to a single-function printer, as well as to a multifunction peripheral which is an image reading/recording apparatus that integrally includes a plurality of functions such as a scanner function, a copy function, and a facsimile function. Further, the present invention can be applied to printers employing various methods other than the inkjet method, such as an electrophotographic method, a thermal method, and a dot impact method.

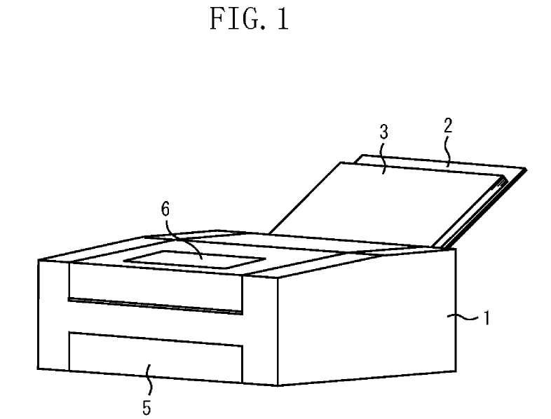

FIG. 1 is a perspective view illustrating an external appearance of a printer according to the present exemplary embodiment.

Referring to FIG. 1, a sheet cassette 5 is disposed in a printer body 1. A sheet medium 3 which is a plurality of cut sheets is stacked and stored in the cassette 5. When a user replenishes the sheet media 3 in the sheet cassette 5, the user pulls out the sheet cassette 5. Further, a sheet supply tray 2 on which the sheet medium 3 is stacked and stored is disposed in the printer body 1 separately from the sheet cassette 5. The printer body 1 thus includes both the sheet cassette 5 and the sheet supply tray 2 as sheet storing units that store the stacked sheet medium 3. A roll sheet can be used as the sheet medium 3 instead of the cut sheets. In such a case, the sheet storing unit is a holder which rotatably holds the roll sheet.

The printer performs printing by picking up a sheet medium 3 from either of the sheet supply tray 2 or the sheet cassette 5 and supplying the sheet medium 3 to a printing unit inside the printer. A display device 6 is an input/output user interface which includes a touch panel.

In the present exemplary embodiment, the sheet supply tray 2 stores high-gloss photo paper, and the sheet cassette 5 stores plain paper as the sheet medium 3 (i.e., printing paper).

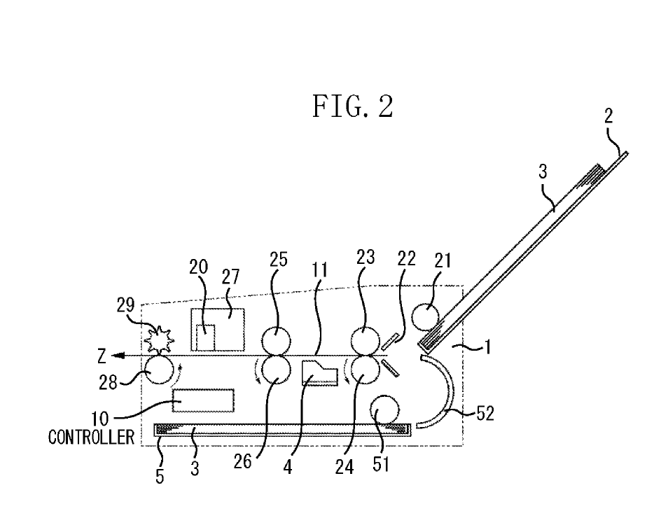

FIG. 2 illustrates a cross-sectional view of an internal configuration of the printer.

Referring to FIG. 2, the sheet media 3 stacked and stored in the sheet supply tray 2 is separated sheet by sheet and picked up by a pick up roller 21, and is conveyed to a paper feed port 22. The sheet media 3 stacked and stored in the sheet cassette 5 is separated sheet by sheet and picked up by a pick up roller 51 and is conveyed to the paper feed port 22 via an individual conveyance path regulated by a guide 52.

After passing through the paper feed port 22, the sheet medium 3 moves along a common conveyance path 11. The sheet medium 3 is then nipped and conveyed by a first roller pair formed by a conveyance roller 24 and a pinch roller 23, and a second roller pair formed by a conveyance roller 26 and a pinch roller 25.

A reader 4 is disposed between the first roller pair and the second roller pair, below the common conveyance path 11. The reader 4 optically reads an identification mark formed on a back side which is opposite to the print side of the sheet medium 3. The reader 4 will be described in detail below.

The printing unit is disposed ahead of the second roller pair above the common conveyance path 11. The printing unit includes a print head 20 which employs an inkjet method, and a carriage 27 which scans the sheet medium 3 in a main scanning direction (direction perpendicular to a direction of the common conveyance path 11) while holding the print head 20. Various inkjet methods are applicable to the print head 20, such as a thermal method which uses a heating element to discharge ink, a piezoelectric method using a piezoelectric element, an electrostatic method using an electrostatic actuator, and a method using a micro electromechanical systems (MEMS) element.

In the printing unit, printing is performed by the first roller pair and the second roller pair conveying the sheet medium 3 in a direction along the common conveyance path 11 (i.e., a sub-scanning direction) while the print head 20 moves in a direction perpendicular to the sub-scanning direction (i.e., the main scanning direction). As a result, a two-dimensional image is formed on the print side of the sheet medium 3.

A discharge roller 28 and a spur 29 then discharge the sheet medium 3 on which the image is formed in a direction indicated by an arrow Z illustrated in FIG. 2.

A controller 10 is a controlling unit which controls the entire printer.

Operations for reading the identification mark formed on the back side of the sheet medium by the reader 4, and print setting based on a read result will be described below.

The sheet medium 3 is conveyed at a constant speed along the common conveyance path 11 by the first roller pair. The reader 4 is disposed along the common conveyance path 11, facing the side opposite to the print side (i.e., the back side) of the sheet medium 3. The reader 4 reads the identification mark formed on the back side of the sheet medium 3 from the back side of the sheet medium 3 moving at the constant speed. The identification mark is drawn as a pattern in which information about a type and a size of the sheet medium 3 is coded, as will be described below.

The controller 10 identifies the information about the type, the size, or the like of the sheet medium 3 according to an output of the reader 4. Further, the controller 10 selects a print quality mode from a plurality of quality modes which are previously stored, so that the print quality (such as a method of ink impacting) appropriate for the type and size of the print medium 3 can be achieved.

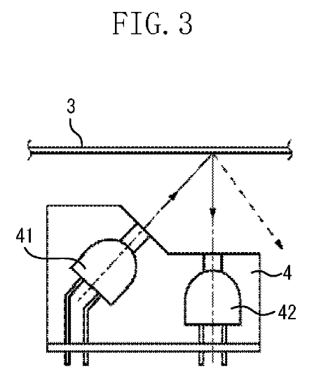

FIG. 3 is a cross-sectional view illustrating a configuration of the reader 4. The reader 4 is a reflective optical sensor formed into a unit which integrally includes an emitter 41 and a detector 42.

The emitter 41 includes a light source (such as an ultraviolet light emitting diode (LED) or an ultraviolet laser diode (LD)) that mainly generates the ultraviolet light (of a predetermined wavelength in the range of wavelengths between 300 nm and 400 nm). The emitter 41 emits the ultraviolet light in a form of a small spot from an oblique direction on a surface of the sheet medium 3.

The detector 42 includes a light receiving element (such as a photodiode or a phototransistor). The detector 42 photo-electrically converts received light scattered in a direction proximately perpendicular to the spot on the sheet medium 3 which is irradiated with the ultraviolet light. The detector 42 does not detect directly reflected light (i.e., 0th order light) of the ultraviolet light which is indicated by a dashed arrow illustrated in FIG. 3. An output from the light receiving element of the detector 42 is input to the controller 10.

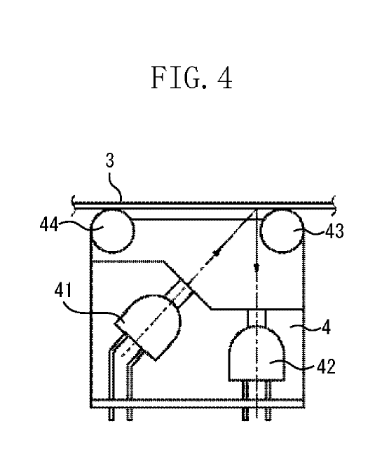

FIG. 4 illustrates another example of the reader 4 in which two rollers 43 and 44 are rotatably disposed facing the sheet medium 3. When the identification mark is read, the rollers 43 and 44 contact the surface of the sheet medium 3 and maintain a predetermined space between the sheet medium 3 and the reader 4. Since the rollers 43 and 44 are rotatable, the rollers 43 and 44 do not apply resistance on the movement of the sheet medium 3 or scratch the sheet medium 3 by contacting the sheet medium 3.

When the emitter 41 emits light (excitation light) including ultraviolet light on the sheet medium 3, fluorescence whose wavelength is different from the ultraviolet light (i.e., fluorescence in a visible light region in the vicinity of a center wavelength between 420 nm and 450 nm) is excited and generated from a fluorescent whitening agent contained in the sheet medium 3. The excited fluorescence thus enters the detector 42 together with the ultraviolet light.

If light receiving sensitivity of the light receiving element in the detector 42 is high in the visible light region, and low or nearly none in the ultraviolet light region, the detector 42 mainly detects the fluorescence and hardly detects the ultraviolet light. A wavelength selective filter can be disposed in front of the light receiving element in the detector 42, so that light with a wavelength in the vicinity of 420 nm and 450 nm is selected. As a result, the light receiving sensitivity becomes higher in the visible light (fluorescence) region compared to the ultraviolet light region.

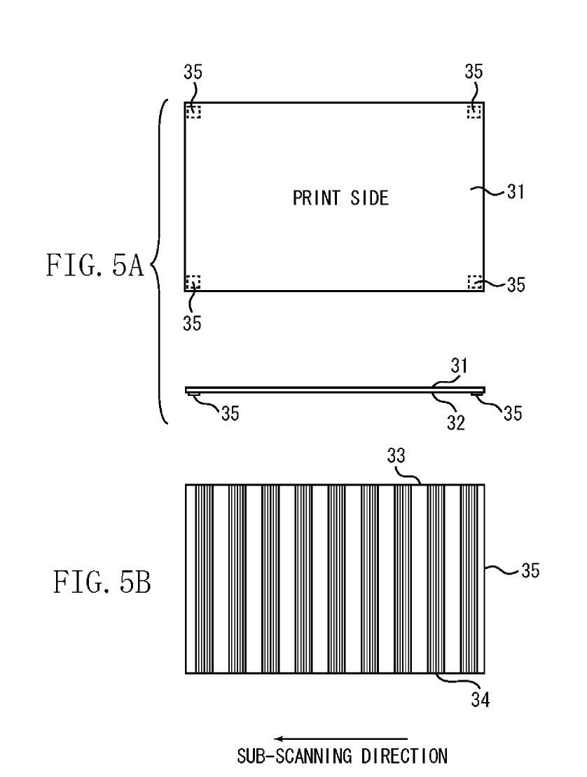

FIG. 5A illustrates the sheet medium 3 according to the present exemplary embodiment.

Referring to FIG. 5A, the sheet medium 3 is printing paper including a print side 31 on which an image is formed, and an opposite side (back side) 32 of the print side 31. An ink receiving layer or a gloss treatment is provided on the print side 31. In the present exemplary embodiment, the sheet medium 3 is high gloss photo paper or plain paper. In general, most printing paper contain the fluorescent whitening agent to increase whiteness thereof, and the paper used in the present exemplary embodiment also contains the fluorescent whitening agent.

Referring to FIG. 5B, an identification mark 35 is formed on a predetermined position in the back side 32 of the sheet medium 3 which is the opposite side of the print side 31. The identification mark 35 is a coded pattern which indicates information about the type or the size of the sheet medium 3. The material used to draw the pattern of the identification mark 31 contains a substance that scatters or absorbs ultraviolet light and does not contain a fluorescent substance.

The substance which “scatters or absorbs ultraviolet light” as described above is not limited to a substance that completely scatters or absorbs ultraviolet light, and can be a substance which restricts transmission of the ultraviolet light by a certain amount of scattering and absorption.

Further, the substance that “does not include a fluorescent substance” as described above is not limited to a substance that does not include any fluorescent substance. More specifically, the substance can include a small amount of fluorescent substance which generates weak fluorescence distinguishable from the fluorescence generated from the fluorescent whitening agent contained in the sheet medium 3.

Further, color of the pattern (i.e., a masking portion) of the identification mark 35 is white, which is the same as the color of the paper, or a similar color. For example, it is desirable to use a white pigment including titanium oxide microparticles or zinc oxide microparticles to form the pattern. Since titanium oxide and zinc oxide are commonly used materials, it is unnecessary to use a special ink and cost effective. Further, a white pigment can form a mark at a level that is hardly visible to the user. Furthermore, the white pigment containing titanium oxide microparticles or zinc oxide microparticles has a high affinity for ink used in the printer. Therefore, it has an advantage that the pattern is not noticeable even if the ink is applied to the pattern when two-sided printing is performed.

Returning to FIG. 5B, the identification mark 35 is a coded pattern in which a plurality of vertical bars is aligned along the sub-scanning direction. A masking portion 33 that restricts the ultraviolet light and a transmitting portion 34 that does not restrict the ultraviolet light are alternately drawn in the pattern.

As describe above, a material containing the substance that scatters or absorbs ultraviolet light and containing no fluorescent substance is applied to the paper in the masking portion 33. Actually, the white pigment is applied to the masking portion 33. On the contrary, nothing is applied to the transmitting portion 34. Therefore, if the ultraviolet light is emitted to the masking portion 33, the ultraviolet light is scattered or absorbed, so that the fluorescence is not generated or weak even if it is generated. On the other hand, if the ultraviolet light is emitted to the transmitting portion 34, the paper is irradiated with the ultraviolet light and the fluorescence is scattered by the fluorescent whitening agent.

In FIG. 5B, the pattern is drawn at constant intervals. However, in the actual pattern, the information is coded by changing the intervals or the number of the plurality of vertical bars according to the type and size of the sheet medium 3. Further, in the pattern, the plurality of vertical bars is aligned along the sub-scanning direction so that the pattern is readable while being scanned. Additionally, each bar is drawn in a direction perpendicular to the sub-scanning direction, or in a direction which intersects the sub-scanning direction at an angle other than the perpendicular direction.

It is desirable that the identification marks 35 are positioned in the vicinity of both edges of the sheet medium 3 in the longitudinal direction so that the user can set the sheet medium 3 in either orientation. In the example illustrated in FIG. 5A, the identification marks 35 are disposed on four corners of the sheet medium 3. The identification mark can thus be read when the sheet edge reaches the reader 4, regardless of the orientation of the conveyed sheet medium 3. The identification mark can also be placed on the entire surface of the sheet medium 3 instead of a part of the sheet medium 3.

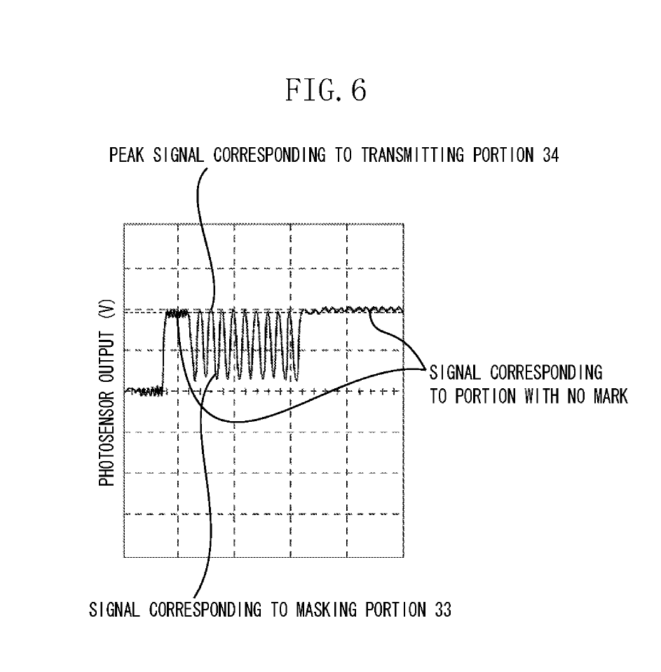

As described above, the sheet medium 3 moves at the constant speed in the sub-scanning direction to the reader 4. Therefore, an output signal which is temporally-modulated according to the pattern is acquired from the reader 4. FIG. 6 illustrates an example of such an output signal.

Referring to FIG. 6, a signal of the fluorescence reaches a peak at the transmitting portion 34, and decreases at the masking portion 33. A number of signal amplitudes and duration change according to the pattern. The fluorescence is continually output from the paper at a portion where there is no pattern, so that a constant signal is continually output.

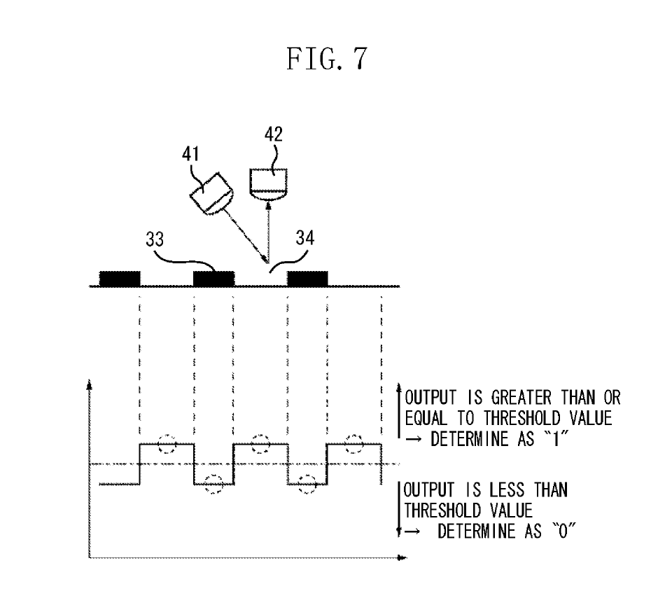

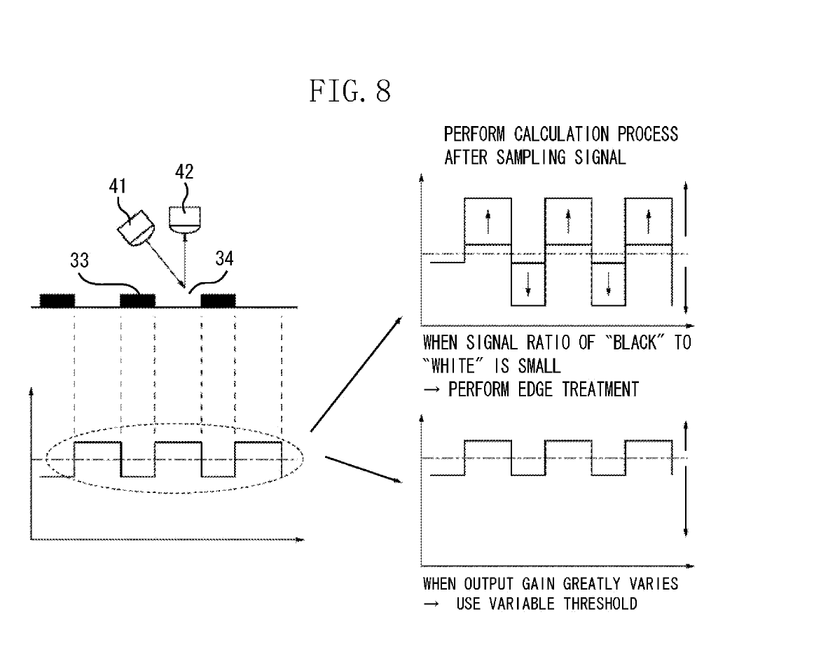

The reader 4 reads the code from the output signal and acquires the information about the sheet medium 3. Such process is performed using algorithm illustrated in FIG. 7 or FIG. 8.

Referring to FIG. 7, the output signal is compared with a threshold value in real time, and a value of “1” or “0” is determined to digitize the signal. A process circuit used to perform the algorithm illustrated in FIG. 7 is simple and can be realized at low cost.

FIG. 8 illustrates a method which further improves detection accuracy by considering calibration and light source life. Referring to FIG. 8, the signal is once stored in a memory to perform sampling. An edge treatment or a comparison process using a variable threshold is performed as illustrated in FIG. 8. As compared to the algorithm illustrated in FIG. 7, the algorithm illustrated in FIG. 8 requires a memory for sampling, and the processing time is increased. However, the algorithm illustrated in FIG. 8 is effective in performing a precise detection.

In the present exemplary embodiment, the pattern formed as a one-dimensional bar code is read while scanning. As a modified example, the pattern of the identification mark can be instantly read using an array sensor such as a charge-coupled device (CCD). In such a case, an emitting spot size of the emitter 41 in the reader 4 is set to a size which can cover the entire pattern of the identification mark. Further, an array sensor which selectively receives the fluorescence wavelength is used as the detector 42. The reader 4 thus instantly reads the fluorescence which is spatially modulated by the pattern. In this case, a two-dimensional code can be used for the pattern in addition to the one-dimensional bar code.

As described above, a reading position of the reader 4 is upstream of a recording position of the printing unit in a conveyance direction of the sheet medium 3. Therefore, the reader 4 reads the identification mark before printing is started. The controller 10 then specifies the print settings for the sheet medium to be used based on the read result. If the reader 4 detects the identification mark and identifies the type and size of the sheet medium 3, the controller 10 automatically sets the printing quality and size appropriate to the paper and performs printing.

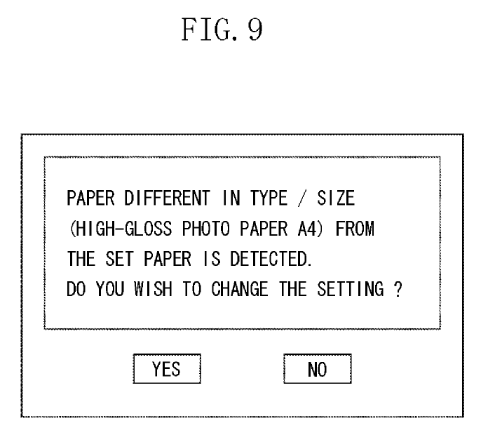

If the identified paper is different from the paper already set by the user, the printer can request the user to confirm whether to change the setting and wait for a user instruction before printing. FIG. 9 illustrates an example of a screen displayed on a user interface in such a case.

Referring to FIG. 9, the display device 6 of the printer displays “Paper different in type/size (high-gloss photo paper A4) from the set paper is detected. Do you wish to change the setting? Yes/No”. The display device 6 then receives the user instruction, and the printer performs a setting process accordingly. More specifically, if the user selects “Yes”, the setting is updated, and if the user selects “No”, the setting is not updated.

On the other hand, if the identification mark is not detected, printing is performed according to the print quality appropriate for the paper which is already set by the user or which is previously set as a default. If the user uses paper which has no identification mark on the back side, the signal output illustrated in FIG. 6 becomes nearly flat. Since the signal level at a flat portion varies depending on whether the paper contains the fluorescent whitening agent, whether the fluorescent whitening agent is contained in the paper can be determined by the signal level. Accordingly, for example, a high-quality paper (containing the fluorescent whitening agent) can be distinguished from a recycled paper (containing no fluorescent whitening agent).

According to the above-described exemplary embodiment, the identification mark can be reliably detected even if the identification mark is so unnoticeable that it is hardly visible. Further, the printing unit and the reader are separately disposed above and below the common conveyance path (i.e., the sheet medium). Therefore, restriction on arrangement within the printer is small and miniaturization of the printer can be realized.

A comparison between a case where the identification mark is formed using a fluorescent substance on a sheet containing the fluorescent whitening agent with the present exemplary embodiment will be described below. If the identification mark is formed using the fluorescent substance, fluorescence is generated from both the fluorescent substance mark and the sheet when the sheet is irradiated with the ultraviolet light. As a result, a signal and noise (S/N) ratio in detection becomes deteriorated with respect to the fluorescence generated from the identification mark, which is to be originally detected.

In contrast, according to the present exemplary embodiment, the identification mark can be reliably detected by forming the pattern by masking with a material containing a substance that scatters or absorbs ultraviolet light and containing no fluorescent substance.

Therefore, according to the above-described exemplary embodiment, the identification mark on the sheet medium can be reliably detected even if the identification mark is visually unnoticeable. The type and size of the sheet medium can thus be identified based on the detection result, and apparatus settings can be specified. Accordingly, the exemplary embodiment of the present invention can provide a highly practicable printer, setting method of the printer, and printing paper.

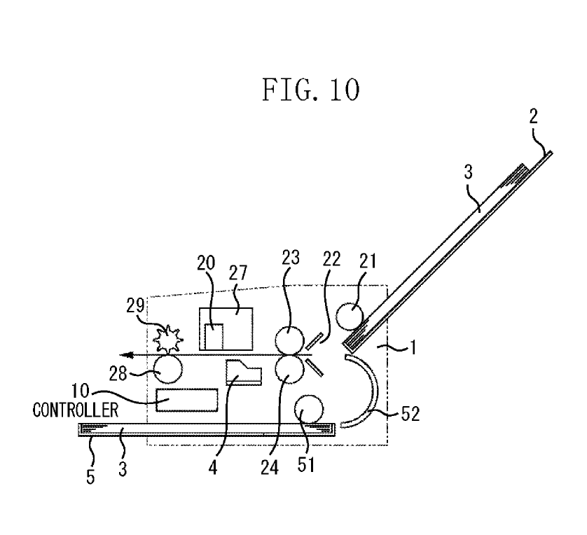

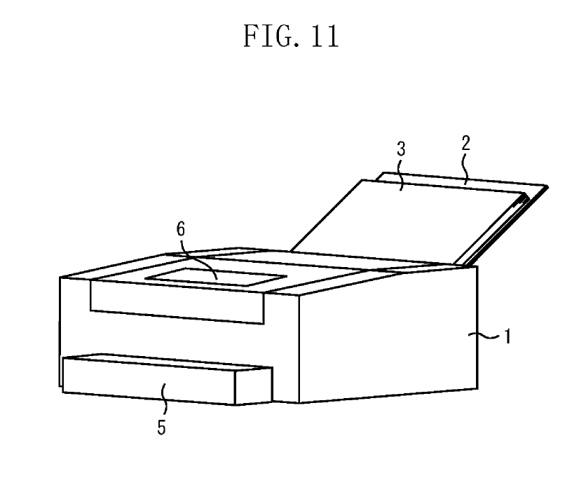

Another exemplary embodiment of the present invention in which downsizing of the printer in the above-described exemplary embodiment can be further realized will be described below with reference to FIGS. 10 and 11.

Referring to FIG. 10, the reader 4 is disposed at a position facing the printing unit across the common conveying path 11 and the sheet medium 3. The second roller pair illustrated in FIG. 2 is omitted. The remaining configuration is similar to the configuration of the printer illustrated in FIG. 2, and a detailed description will be omitted. According to the configuration illustrated in FIG. 10, the printing unit and the reader 4 are separately disposed above and below the common conveyance path 11, facing each other. Thus, the arrangement of each unit is highly integrated to realize downsizing.

Since the reading position of the reader 4 is upstream of the recording position of the printing unit in the conveyance direction of the sheet medium 3, reading is performed before printing is started. Further, the reading position of the reader 4 is close to the recording position of the print head 20. Therefore, it is necessary to finish specifying print settings by reading the identification mark on the leading edge of the conveyed sheet medium 3 before the leading edge of the sheet medium 3 reaches the recording position.

It is thus desirable to dispose the identification mark at least in the vicinity of both ends of the sheet medium 3 in the longitudinal direction, so that the identification mark can be read immediately when the leading edge of the sheet medium 3 reaches the reader 4. As described above, the identification marks are disposed on both edges of the sheet medium 3 to enable handling even if either orientation thereof is set by the user.

FIG. 11 is a perspective view illustrating an external appearance of the printer illustrated in FIG. 10. The length of the printer illustrated in FIG. 11 is shorter in the sub-scanning direction (forward direction) compared to the printer illustrated in FIG. 1, so that downsizing is further realized.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-210763 filed Aug. 19, 2008, which is hereby incorporated by reference herein in its entirety.

What is claimed is:

1. A printer comprising:
a printing unit configured to print on a sheet medium;
a reading unit configured to read an identification mark when a sheet medium on which the identification mark is formed is used; and
a control unit configured to make a print setting for the sheet medium based on a read result of the reading unit,
wherein the identification mark is a coded pattern drawn using a material containing a substance that scatters or absorbs ultraviolet light and containing no fluorescent substance, and
wherein the reading unit includes an emitter configured to mainly emit ultraviolet light and a detector configured to detect fluorescence generated by excitation from a fluorescent whitening agent contained in the sheet medium and modulated by the pattern.

2. The printer according to claim 1, wherein the material used for drawing the pattern is a white pigment which includes titanium oxide microparticles or zinc oxide microparticles.

3. The printer according to claim 1, wherein the identification mark is formed at least in the vicinity of both ends of the sheet medium in a longitudinal direction.

4. The printer according to claim 1, wherein the identification mark is a pattern in which information for identifying a type or a size of the sheet medium is coded, and
wherein the control unit sets a print quality according to the read result of the reading unit.

5. The printer according to claim 1, wherein the reading unit reads the sheet medium while moving the sheet medium, and
wherein the detector detects fluorescence temporally modulated by the pattern.

6. The printer according to claim 1, wherein the reading unit is disposed at a position facing the printing unit across the sheet medium.

7. The printer according to claim 1, wherein a reading position of the reading unit is upstream of a recording position of the printing unit in a conveyance direction of the sheet medium, so that the identification mark is read before printing.

8. The printer according to claim 7, further comprising a plurality of sheet storing units that store the sheet medium to be supplied,
wherein the reading position of the reading unit is disposed in the vicinity of a common conveyance path through which the sheet medium supplied from each of the plurality of sheet storing units are commonly conveyed.

9. The printer according to claim 1, wherein the reading unit includes a rotatable roller facing the sheet medium while reading the identification mark.

10. The printer according to claim 1, further comprising a unit configured to request confirmation from a user when a type or a size of the identified sheet medium is different from a type or a size of a sheet medium which is already set.

11. The printer according to claim 1, further comprising a unit configured to print, if the identification mark cannot be read, at a print quality which is already set.

12. The printer according to claim 1, wherein the printing unit includes a print head which prints using an inkjet process.

13. A method for setting a printer by reading an identification mark formed on a sheet medium, wherein the sheet medium contains a fluorescent whitening agent, and wherein the identification mark is a coded pattern drawn using a material containing a substance that scatters or absorbs ultraviolet light and containing no fluorescent substance, the method comprising:
irradiating the sheet medium with light including ultraviolet light;
detecting fluorescence generated from the fluorescent whitening agent by the irradiation and modulated by the pattern; and
making the print setting for the sheet medium based on a signal acquired by detecting the modulated fluorescence.

14. The method according to claim 13, wherein the material used for drawing the pattern is a white pigment which includes titanium oxide microparticles or zinc oxide microparticles.

15. A printing paper made of a substance containing fluorescent whitening agent, wherein the printing paper comprises an identification mark formed on a side opposite to a print side, which is a coded pattern of information for identifying a type or a size of a printing paper, and is drawn using a material containing a substance that scatters or absorbs ultraviolet light and containing no fluorescent substance.

16. The printing paper according to claim 15, wherein the material is a pigment which is of a same as or a similar color to the printing paper.

17. The printing paper according to claim 15, wherein the material is a white pigment which includes titanium oxide microparticles or zinc oxide microparticles.

18. The printing paper according to claim 15, wherein the identification mark is formed at least in the vicinity of both ends of the sheet medium in a longitudinal direction.
